(19) United States
(12) Patent Application Publication
(10) Pub. No.: US 2020/0282683 A1
(43) Pub. Date: Sep. 10, 2020

(54) SHEET FOLDING DEVICE AND BOX-MAKING MACHINE

(71) Applicant: MITSUBISHI HEAVY INDUSTRIES MACHINERY SYSTEMS, LTD, Hyogo (JP)

(72) Inventors: Kazuya AKITA, Hyogo (JP); Makoto SHIMOHATSUBO, Hyogo (JP)

(21) Appl. No.: 16/305,054

(22) PCT Filed: Oct. 13, 2017
(86) PCT No.: PCT/JP2017/037214

§ 371 Date: Nov. 28, 2018

(30) Foreign Application Priority Data
Oct. 20, 2016 (JP) 2016-206278

(51) Int. Cl. B31B 50/04; B31B 50/00; B31B 50/36; B31B 50/88

(52) U.S. Cl. CPC B31B 50/044; B31B 50/006; B31B 50/36; B31B 50/54; B31B 50/88; B31B 50/005; B31B 50/042

(57) ABSTRACT

A sheet folding device and a box-making machine, wherein are provided folding guides disposed along a transfer direction on both sides in the transfer direction of a cardboard sheet, guide plates disposed downstream from the folding guides along the transfer direction on both sides in the transfer direction of the cardboard sheet, gauge roller groups disposed along the transfer direction further outside in the width direction of the cardboard sheet than the folding guides and the guide plates, folding guide adjustment devices for adjusting the width-direction position of the cardboard sheet in the folding guides, and a second gauge roller adjustment device for adjusting the width-direction position of at least gauge rollers disposed facing the second folding guide from among the gauge roller groups.

### RELATED APPLICATIONS

The present application is a National Phase of International Application Number PCT/JP2017/037214 filed Oct. 13, 2017 and claims priority to Japanese Application Number 2016-206278 filed Oct. 20, 2016.

### TECHNICAL FIELD

The present invention relates to a sheet folding device which forms a flat corrugated box by folding a corrugated fiberboard while transferring the corrugated fiberboard in a process of manufacturing a corrugated box and a box making machine including the sheet folding device.

### BACKGROUND ART

A general box making machine manufactures a box body (corrugated box) by processing a sheet material (for example, a corrugated fiberboard), and includes a sheet feeding section, a printing section, a slotter creaser section, a die cutting section, a folding section (folder gluer), and a counter-ejector section. In the sheet feeding section, the corrugated fiberboards stacked on a table are fed to the printing section one by one at a constant speed. The printing section includes a printing unit and performs printing on the corrugated fiberboard. In the slotter creaser section, creasing lines which become folding lines are formed on the printed corrugated fiberboard, and processing of grooves becoming flaps or gluing margin strips for joining is performed. In the die cutting section, punching such as hand hole is performed on the corrugated fiberboard on which the creasing lines, the grooves, and gluing margin strips are formed. In the folding section, glue is applied to the gluing margin strip and the corrugated fiberboard on which the creasing lines, the grooves, the gluing margin strips, and the hand holes are formed is folded along the creasing lines while the corrugated fiberboard moves, and the gluing margin strips are joined to each other to manufacture a flat corrugated box. In addition, in the counter-ejector section, the corrugated boxes in which corrugated fiberboards are folded and glued are stacked, the stacked corrugated boxes are sorted by a predetermined number of batches, and the sorted corrugated boxes are discharged.

In the above-described folding section, folding rails and guide plates are disposed in series along a transfer direction on both sides of the corrugated fiberboard in the transfer direction, several gauge rollers are disposed outside the folding rails and guide plates along the transfer direction, and a folding belt and a folding bar are disposed. Accordingly, the corrugated fiberboard is transferred while a position in a width direction is restricted by the folding rails and is pressed by the folding belt and the folding bar, and thus, both end portions in the width direction are bent downward. In addition, when both end portions in the width direction of the corrugated fiberboard are bent downward, bending portion sides of both ends in the width direction of the corrugated fiberboard are held by the several gauge rollers, both bent end portions are closely adhered to the inside, and a flat corrugated box is formed.

The sheet folding device of the related art is disclosed in PTL 1 and PTL 2 below.

### CITATION LIST

### Patent Literature

[PTL 1] Japanese Patent No. 4701062

[PTL 2] Japanese Patent No. 4609809

### SUMMARY OF INVENTION

### Technical Problem

In the above-described sheet folding device, at an initial stage where both end portions in the width direction of the corrugated fiberboard are bent downward, an inner side of the corrugated fiberboard is restricted by the folding rails and an outer side thereof is restricted by the gauge rollers. The corrugated fiberboard has different rigidities according to a thickness, a nature, a shape, or the like of a liner or a core paper. If the corrugated fiberboard has a high rigidity, when the corrugated fiberboard is clamped by the folding rails and the gauge rollers, the corrugated fiberboard is bent at the position of the creasing lines which are formed in advance. Meanwhile, if the corrugated fiberboard has a low rigidity, when the corrugated fiberboard is clamped by the folding rails and the gauge rollers, the corrugated fiberboard may be bent inside the creasing lines, that is, on a center side in the width direction of the corrugated fiberboard. In this case, an adjustment for moving the folding rail and the gauge roller outward in the width direction is performed in a state where a gap between the folding rail and the gauge roller is maintained.

Meanwhile, if the folding rails and the gauge rollers are moved outward in the width direction, in the sheet folding device of PTL 1, a gap between the guide plate and the gauge roller is widened on the downstream side of a first correction roller group. In addition, in the corrugated fiberboard, if a folding process progresses, the bending portion tends to be slightly inward. Accordingly, if a position of the gauge roller is moved outward, a gap between the guide plate and the folding portion increases, and thus, an error occurs at a bending position of the corrugated fiberboard.

The present invention is made in order to solve the above-described problems, and an object thereof is to provide a sheet folding device and a box making machine capable of improving bending accuracy of the corrugated fiberboard.

### Solution to Problem

In order to achieve the above-described object, according to an aspect of the present invention, there is provided a sheet folding device which bends and folds both end portions in a width direction of a transferred corrugated fiberboard, including: folding rails which are disposed along a transfer direction on both sides in the transfer direction of the corrugated fiberboard; guide plates which are disposed on downstream sides of the folding rails along the transfer direction on both sides in the transfer direction of the corrugated fiberboard; a gauge roller group including several gauge rollers which are disposed outside the folding rails and the guide plates in a width direction of the corrugated fiberboard, along the transfer direction of the corrugated fiberboard; a folding rail adjustment device which adjusts positions of the folding rails in the width direction of the corrugated fiberboard; and a gauge roller adjustment device which adjusts a position of at least the gauge roller of the gauge roller group, which is disposed to face the folding rail, in the width direction of the corrugated fiberboard.

Accordingly, when the position of the folding rail in the width direction of the corrugated fiberboard is adjusted by the folding rail adjustment device, the position in the width direction of the corrugated fiberboard of at least the gauge roller of the gauge roller group facing the folding rail is adjusted by the gauge roller adjustment device. Therefore, even when positions of the folding rail and the gauge roller facing each other or a gap therebetween is adjusted according to a material or the like of the corrugated fiberboard, a gap between the guide plate and the gauge roller is maintained at an appropriate gap, the corrugated fiberboard can be bent at an appropriate position, and it is possible to improve bending accuracy of the corrugated fiberboard.

In the sheet folding device of the present invention, the gauge roller adjustment device moves an upstream side of the gauge roller group close to or away from the folding rail with a downstream side of the gauge roller group in the transfer direction of the corrugated fiberboard as a supporting point.

Accordingly, when the position of the folding rail in the width direction is adjusted, the gauge roller group rotates with the downstream side as the supporting point, the position of the gauge roller on the upstream side in the width direction is adjusted, the position of the gauge roller facing the folding rail can be appropriately adjusted, and it is possible to bend the corrugated fiberboard at an appropriate position without largely changing the position of the gauge roller facing the guide plate.

In the sheet folding device of the present invention, the gauge roller adjustment device moves the gauge roller of the gauge roller group disposed to face the folding rail close to or away from the folding rail.

Accordingly, when the position of the folding rail in the width direction is adjusted, only the gauge roller disposed to face the folding rail moves and the position thereof in the width direction is adjusted, the position of the gauge roller facing the folding rail can be appropriately adjusted, and it is possible to bend the corrugated fiberboard at an appropriate position without changing the position of the gauge roller facing the guide plate.

In the sheet folding device of the present invention, the folding rail includes a first folding rail and a second folding rail which are disposed in series in the transfer direction of the corrugated fiberboard and have end portions rotatably connected to each other, and the folding rail adjustment device moves the first folding rail and the second folding rail in parallel in the width direction of the corrugated fiberboard and changes an angle of the second folding rail by moving the first folding rail in parallel in the width direction of the corrugated fiberboard.

Accordingly, the first folding rail and the second folding rail move in parallel in the width direction, the first folding rail moves in parallel in the width direction so as to change the angle of the second folding rail, and it is possible to easily adjust the position of the gauge roller facing the second folding rail.

In the sheet folding device of the present invention, the gauge roller group includes a first gauge roller group and a second gauge roller group which are disposed in series in the transfer direction of the corrugated fiberboard, and the gauge roller adjustment device moves the first gauge roller group in parallel in the width direction of the corrugated fiberboard and changes angles of the first gauge roller group and the second gauge roller group independently.

Accordingly, the angle of the first gauge roller group is changed, and thus, it is possible to easily adjust the position of the gauge roller facing the second folding rail.

The sheet folding device of the present invention further includes a control device which controls the folding rail adjustment device and the gauge roller adjustment device, in which the control device controls the gauge roller adjustment device such that a gap between the folding rail and the gauge roller when the folding rail is moved by the folding rail adjustment device falls within a predetermined gap region which is set in advance.

Accordingly, the position of the folding rail, the position of the gauge roller, and the gap between the folding rail and the gauge roller can be easily adjusted to appropriate positions or an appropriate gap, and thus, workability can be improved.

The sheet folding device of the present invention further includes a guide measurement sensor which measures a position of the folding rail, a roller measurement sensor which measures a position of the gauge roller group, and a control device which controls the folding rail adjustment device and the gauge roller adjustment device based on a measurement result of the guide measurement sensor and a measurement result of the roller measurement sensor.

Accordingly, the position of the folding rail and the position of the gauge roller group are measured, and the folding rail adjustment device and the gauge roller adjustment device are controlled based on the measurement result. Therefore, it is possible to accurately adjust the position of the folding rail, the position of the gauge roller, and the gap between the folding rail and the gauge roller, and it is possible to improve quality of a product.

In the sheet folding device of the present invention, a recessed portion holding a bending portion of the corrugated fiberboard is provided in each of the several gauge rollers, and a holding belt is wound around a bottom surface portion of the recessed portion of each of the several gauge rollers.

Accordingly, the corrugated fiberboard is transferred while the bending portion is continuously supported by the holding belt provided in the recessed portion of each gauge roller, the corrugated fiberboard does not fall between the respective gauge rollers, the posture of the corrugated fiberboard does not deteriorate, and the corrugated fiberboard can be stably transferred.

The sheet folding device of the present invention further includes a drive device which drives the gauge roller.

Accordingly, if the one gauge roller is driven by the drive device, the drive force is transmitted to all the gauge rollers via the holding belt, all the gauge rollers can be synchronously rotated, a drive system of the gauge roller is simplified, and a cost can be reduced.

In addition, according to another aspect of the present invention, there is provided a box making machine including: a sheet feeding section which supplies a corrugated fiberboard; a printing section which performs printing on the corrugated fiberboard; a slotter creaser section which performs creasing line processing and slicing on the printed corrugated fiberboard; a folding section which includes the sheet folding device; and a counter-ejector section which stacks flat corrugated boxes while counting the flat corrugated boxes and thereafter, discharges the flat corrugated boxes every predetermined number.

Accordingly, the printing is performed on the corrugated fiberboard from the sheet feeding section in the printing section, the creasing line processing and the slicing are performed in the slotter creaser section, the corrugated fiberboard is folded in the folding section such that the end portions are joined to each other so as to form the box body, and the box bodies are stacked while being counted in the counter-ejector section. In this case, in the sheet folding device, when the position of the folding rail in the width direction of the corrugated fiberboard is adjusted by the folding rail adjustment device, the position in the width direction of the corrugated fiberboard of at least the gauge roller of the gauge roller group facing the folding rail is adjusted by the gauge roller adjustment device. Accordingly, the positions of the folding rail and the gauge roller, the gap therebetween, or the gap between the guide plate and the gauge roller can be appropriately adjusted according to a material or the like of the corrugated fiberboard, it is possible to improve bending accuracy of the corrugated fiberboard, and it possible to improve the quality of the product.

### Advantageous Effects of Invention

According to the sheet folding device and the box making machine of the present invention, the folding rail adjustment device which adjusts the position of the folding rail in the width direction and the gauge roller adjustment device which adjusts the position of the gauge roller facing the folding rail in the width direction are provided, and thus, it is possible to bend the corrugated fiberboard at an appropriate position, and it is possible to improve the bending accuracy of the corrugated fiberboard.

### BRIEF DESCRIPTION OF DRAWINGS

FIG. 1 is a schematic configuration view showing a box making machine of the present embodiment.

FIG. 2 is a schematic plan view showing a sheet folding device of the present embodiment.

FIG. 3 is a schematic side view showing the sheet folding device.

FIG. 4 is a sectional view taken along line Iv-Iv of FIG. 2.

FIG. 5 is a schematic view showing a folding rail position adjustment device.

FIG. 6 is an explanatory view showing a position adjustment method of folding rails and gauge rollers.

FIG. 7A is a schematic view showing a bending state of a corrugated fiberboard of the related art.

FIG. 7B is a schematic view showing the bending state of the corrugated fiberboard of the related art.

FIG. 8 is a schematic view showing a bending state of a corrugated fiberboard of the present embodiment.

FIG. 9 is a schematic view showing a first modification example of the sheet folding device of the present embodiment.

FIG. 10 is a schematic view showing a second modification example of the sheet folding device of the present embodiment.

FIG. 11 is a schematic view showing a third modification example of the sheet folding device of the present embodiment.

FIG. 12 is a sectional view of a gauge roller.

### DESCRIPTION OF EMBODIMENTS

Hereinafter, preferred embodiments of a sheet folding device and a box making machine according to the present invention will be described in detail with reference to the accompanying drawings. In addition, the present invention is not limited by the embodiment, and in a case where several embodiments are provided, the present invention includes those which are obtained by combining the embodiments.

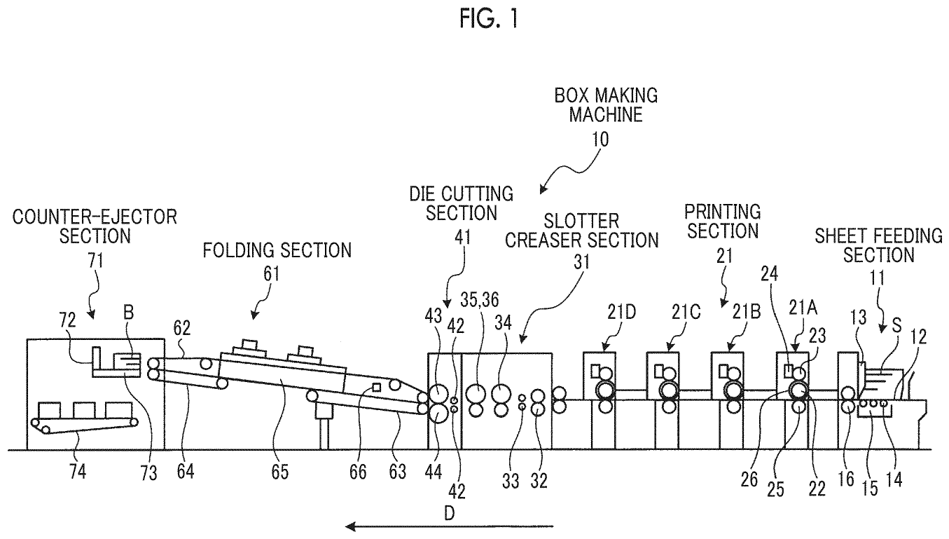

FIG. 1 is a schematic configuration view showing a box making machine of the present embodiment.

In the present embodiment, as shown in FIG. 1, a box making machine 10 manufactures a corrugated box (box body) B by processing a corrugated fiberboard S. The box making machine 10 includes a sheet feeding section 11, a printing section 21, a slotter creaser section 31, a die cutting section 41, a folding section 61, a counter-ejector section 71 which are linearly disposed in a transfer direction D in which the corrugated fiberboard S and the corrugated box B are transferred.

In the sheet feeding section 11, the corrugated fiberboards S are fed to the printing section 21 one by one at a constant speed. The sheet feeding section 11 includes a table 12, a front stopper 13, supply rollers 14, a suction unit 15, and a feed roll 16. Several corrugated fiberboards S are placed on the table 12 so as to be stacked, and the table 12 is supported so as to be lifted and lowered. The front stopper 13 can position the front end position of each of the corrugated fiberboards S stacked on the table 12, and a gap which allows one corrugated fiberboard S to pass through a portion between a lower end portion of the front stopper 13 and the table 12 is secured. Several supply rollers 14 are disposed corresponding to the table 12 in the transfer direction D of the corrugated fiberboard S. When the table 12 is lowered, the corrugated fiberboard S located at the lowermost position of several stacked corrugated fiberboards S can be fed forward by the supply rollers 14. The stacked corrugated fiberboards S are suctioned downward, that is, toward the table 12 side or the supply roller 14 side by the suction unit 15. The feed roll 16 can supply the corrugated fiberboard S fed by the supply rollers 14 to the printing section 21.

The printing section 21 performs multi-color printing (in the first embodiment, four-color printing) on a surface of the corrugated fiberboard S. In the printing section 21, four printing units 21A, 21B, 21C, and 21D are disposed in series, and printing can be performed on the surface of the corrugated fiberboard S using four ink colors. The printing units 21A, 21B, 21C, and 21D are approximately similarly configured to each other, and each of the printing units 21A, 21B, 21C, and 21D includes a printing cylinder 22, an ink supply roll (anilox roll) 23, an ink chamber 24, and a receiving roll 25. A printing die 26 is mounted on an outer peripheral portion of the printing cylinder 22, and the printing cylinder 22 is rotatably provided. The ink supply roll 23 is disposed so as to contact against the printing die 26 in the vicinity of the printing cylinder 22, and is rotatably provided. The ink chamber 24 stores ink and is provided in the vicinity of the ink supply roll 23. The corrugated fiberboard S is interposed between the receiving roll 25 and the printing cylinder 22, the receiving roll 25 transfers the corrugated fiberboard S while applying a predetermined printing pressure to the corrugated fiberboard S, and the receiving roll 25 is rotatably provided so as to face the lower portion of the printing cylinder 22. In addition, although not shown, a pair of upper and lower feed rolls is provided in front of and behind each of the printing units 21A, 21B, 21C, and 21D.

In the slotter creaser section 31, creasing line processing, cutting, slicing, and gluing margin strip processing are performed on the corrugated fiberboard S by the slotter device. The slotter creaser section 31 includes first creasing line rolls 32, second creasing line rolls 33, first slotter heads 34, second slotter heads 35, and slitter heads 36. The first creasing line rolls 32 and the second creasing line rolls 33 perform the creasing line processing on a rear surface (lower surface) of the corrugated fiberboard S. The first slotter head 34 and the second slotter heads 35 perform the slicing on the corrugated fiberboard S at a predetermined position and performs the gluing margin strip processing on the corrugated fiberboard S. The slitter heads 36 are provided to be adjacent to the second slotter heads 35 and cut an end portion in a width direction of the corrugated fiberboard S.

In the die cutting section 41, drilling for forming a hand hole is performed on the corrugated fiberboard S. The die cutting section 41 includes a pair of upper and lower feeding pieces 42, an anvil cylinder 43, and a knife cylinder 44. The feeding pieces 42 are rotatably provided such that the corrugated fiberboard S is transferred in a state where the corrugated fiberboard S is interposed between the upper portion and the lower portion. Each of the anvil cylinder 43 and the knife cylinder 44 is circularly formed, and the anvil cylinder 43 and the knife cylinder 44 are rotatable in synchronization with each other by a drive device (not shown). A head and a die are formed at predetermined positions of an outer peripheral portion of the knife cylinder 44 while an anvil is formed on an outer peripheral portion of the anvil cylinder 43.

In the folding section 61, the corrugated fiberboard S is folded while being moved in the transfer direction D, and both end portions in the width direction of the corrugated fiberboard S are joined to each other so as to form a flat corrugated box B. The folding section 61 includes an upper transfer belt 62, lower transfer belts 63 and 64, and a sheet folding device (folder gluer) 65. The upper transfer belt 62 and the lower transfer belts 63 and 64 transfer the corrugated fiberboard S and the corrugated box B in a state where the corrugated fiberboard S and the corrugated box B are interposed between the upper portion and the lower portion. Although the sheet folding device 65 will be described later, the sheet folding device 65 folds each end portion in the width direction of the corrugated fiberboard S while bending the end portion downward. In addition, the folding section 61 includes a gluing device 66. The gluing device 66 includes a glue gun, glue is ejected at a predetermined timing by the glue gun, and gluing can be applied to a predetermined position of the corrugated fiberboard S.

In the counter-ejector section 71, after the corrugated boxes B are stacked while being counted, the corrugated boxes B are sorted by a predetermined number of batches, and thereafter, the sorted corrugated boxes B are discharged. The counter-ejector section 71 includes a hopper device 72. The hopper device 72 includes an elevator 73 on which corrugated boxes B are stacked and which can be lifted and lowered, and a front stopper and an angle arrangement plate are provided in the elevator 73. In addition, an ejection conveyor 74 is provided below the hopper device 72.

Here, in the box making machine 10 of the above-described embodiment, an operation for manufacturing the corrugated box B from the corrugated fiberboard S is described. In the box making machine 10 of the present embodiment, after printing, creasing line processing, processing of grooves and gluing margin strips, and punching are performed on the corrugated fiberboard S, the corrugated fiberboard S is folded so as to manufacture the corrugated box B.

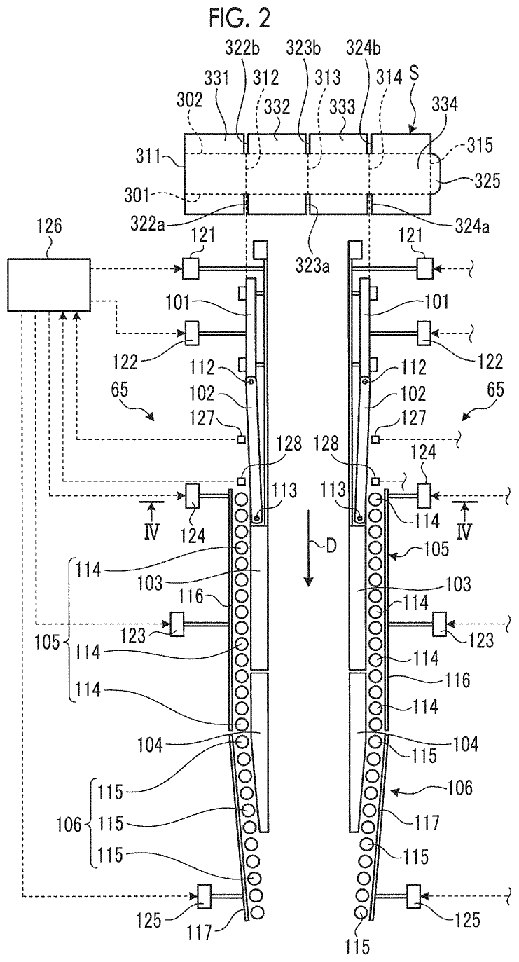

The corrugated fiberboard S is formed by gluing a medium forming a waveform between a bottom liner and a top liner. As shown in FIG. 2, in the corrugated fiberboard S, two folding lines 301 and 302 are formed in a pre-process of the box making machine 10. The folding lines 301 and 302 are used for folding a flap when the corrugated box B manufactured by the box making machine 10 is assembled later. As shown in FIG. 1, the corrugated fiberboards S are stacked on the table 12 of the sheet feeding section 11.

In the sheet feeding section 11, first, the several corrugated fiberboards S stacked on the table 12 are positioned by the front stopper 13, and thereafter, the table 12 is lowered, and the corrugated fiberboard S positioned at the lowermost position is fed by several supply rollers 14. Accordingly, the corrugated fiberboard S is supplied to the printing section 21 at a predetermined constant speed by the pair of feed rolls 16.

In the printing section 21, ink is supplied from the ink chamber 24 to the surface of the ink supply roll 23 in each of the printing units 21A, 21B, 21C, and 21D, and if the printing cylinder 22 and the ink supply roll 23 rotate, the ink on the surface of the ink supply roll 23 is transferred to the printing die 26. If the corrugated fiberboard S is transferred to a portion between the printing cylinder 22 and the receiving roll 25, the corrugated fiberboard S is interposed between the printing die 26 and the receiving roll 25, and a printing pressure is applied to the corrugated fiberboard S so as to perform printing on the surface of the corrugated fiberboard S. The printed corrugated fiberboard S is transferred to the slotter creaser section 31 by the feed rolls.

In the slotter creaser section 31, first, when the corrugated fiberboard S passes through the first creasing line rolls 32, as shown in FIG. 2, creasing lines 312, 313, 314, and 315 are formed on the rear surface (top liner) side of the corrugated fiberboard S. In addition, when the corrugated fiberboard S passes through the second creasing line rolls 33, the creasing lines 312, 313, 314, and 315 are formed on the rear surface (top liner) side of the corrugated fiberboard S again.

Next, when the corrugated fiberboard S in which the creasing lines 312, 313, 314, and 315 are formed passes through the first and second slotter heads 34 and 35, grooves 322a, 322b, 323a, 323b, 324a, and 324b are formed at the positions of the creasing lines 312, 313, and 314. In this case, an end portion is cut at the position of the creasing line 315, and a gluing margin strip 325 is formed. In addition, when the corrugated fiberboard S passes through the slitter heads 36, an end portion is cut at a position of a cutting position 311. Accordingly, the corrugated fiberboard S includes four sheet pieces 331, 332, 333, and 334 which have the creasing lines 312, 313, and 314 (grooves 322a, 322b, 323a, 323b, 324a, and 324b) as boundaries.

In the die cutting section 41, when the corrugated fiberboard S passes through a portion between the anvil cylinder 43 and the knife cylinder 44, a hand hole (not shown) is formed. However, since the hand hole processing is appropriately performed according to the kind of the corrugated fiberboard S, when the hand hole is not required, a blade attachment base (punching blade) for performing the hand hole processing is removed from the knife cylinder 44, and the corrugated fiberboard S passes through the portion between the rotating anvil cylinder 43 and knife cylinder 44. In addition, the corrugated fiberboard S in which the hand hole is formed is transferred to the folding section 61.

In the folding section 61, glue is applied to the gluing margin strip 325 (refer to FIG. 2) by the gluing device 66 while the corrugated fiberboard S is moved in the transfer direction D by the upper transfer belt 62 and the lower transfer belts 63 and 64, and thereafter, the corrugated fiberboards S is folded downward by the sheet folding device 65 with the creasing lines 312 and 314 (refer to FIG. 2) as base points. If this folding advances to nearly 180°, the folding force becomes stronger, the gluing margin strip 325 and the end portion of the corrugated fiberboard S are pressed to each other so as to come into close contact with each other, both end portions of the corrugated fiberboard S are joined to each other, and the corrugated box B is formed. In addition, the corrugated box B is transferred to the counter-ejector section 71.

In the counter-ejector section 71, the corrugated box B is fed to the hopper device 72, a tip portion of the corrugated box B in the transfer direction D abuts on the front stopper, and the corrugated boxes B are stacked on the elevator 73 in a state of being arranged by the angle arrangement plate. In addition, if a predetermined number of corrugated boxes B are stacked on the elevator 73, the elevator 73 is lowered, a predetermined number of corrugated boxes B become one batch, are discharged by the ejection conveyor 74, and are fed to the post-process of the box making machine 10.

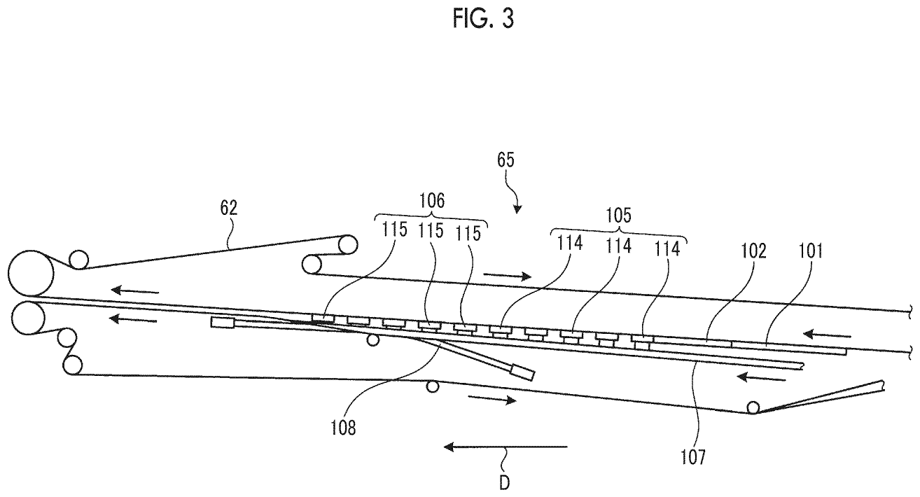

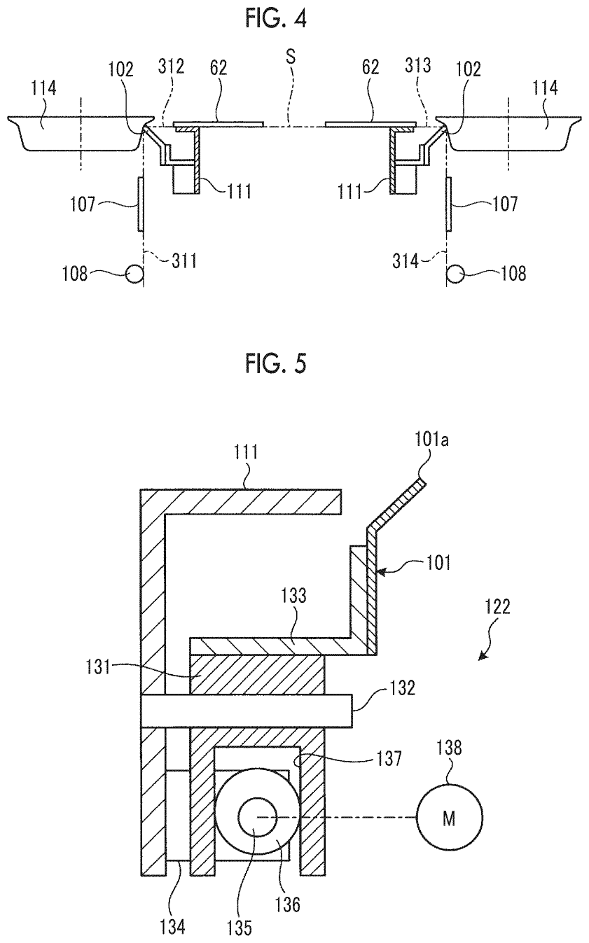

Here, the sheet folding device 65 of the present embodiment will be described in detail. FIG. 2 is a schematic plan view showing the sheet folding device of the present embodiment, FIG. 3 is a schematic side view showing the sheet folding device, FIG. 4 is a sectional view taken along line Iv-Iv of FIG. 2, and FIG. 5 is a schematic view showing a folding rail position adjustment device.

As shown in FIGS. 2 to 4, the sheet folding device 65 includes first folding rails 101, second folding rails 102, first guide plates 103, second guide plates 104, first gauge roller groups 105, second gauge roller groups 106, forming belts 107, and folding bars 108.

A pair of right and left upper transfer belts 62 is provided on an upper side in a vertical direction, and is provided over the entire length of the sheet folding device 65 in the transfer direction D. Each upper transfer belt 62 is an endless belt and is configured to be wound around several pulleys supported by a pair of right and left upper frames (not shown) so that the upper transfer belt 62 can circulate. In each of the circulating upper transfer belts 62, a lower side thereof moves in the transfer direction D and an upper side thereof moves in a direction opposite to the transfer direction D.

A pair of right and left lower frames 111 facing the pair of right and left upper frames is provided vertically below the pair of right and left upper frames, and the pair of right and left upper transfer belts 62 is disposed to face the pair of right and left lower frames 111 above the pair of right and left lower frames 111. A pair of right and left first folding rails 101 and a pair of right and left second folding rails 102 are disposed in series along the transfer direction D on both sides in the transfer direction D of the corrugated fiberboard S. The respective first folding rails 101 and the respective second folding rails 102 are supported outside the pair of right and left lower frames 111. The respective first folding rails 101 are disposed to be approximately parallel in the transfer direction D, and the respective second folding rails 102 are disposed to be inclined such that downstream sides of the respective second folding rails 102 in the transfer direction D approach each other. In addition, downstream end portions of the respective first folding rails 101 in the transfer direction D are rotatably connected horizontally to upstream end portions of the respective second folding rails 102 in the transfer direction D by respective connection shafts 112 along the vertical direction. In addition, downstream end portions of the respective second folding rail 102 in the transfer direction D are rotatably connected horizontally to the lower frames 111 by respective connection shafts 113 along the vertical direction.

In the respective first folding rails 101 and the respective second folding rails 102, positions in a width direction in a bending portion along the transfer direction D are disposed at positions in the width direction corresponding to the respective creasing lines 312 and 314 on a lower surface of the corrugated fiberboard S transferred in the transfer direction D. Accordingly, the corrugated fiberboard S is transferred while sheet pieces 331 and 334 on end portion sides in the width direction are folded downward with respect to respective sheet pieces 332 and 333 on a center side in the width direction at positions at which the respective creasing lines 312 and 314 abut against bending portions of the respective first folding rails 101 and the respective second folding rails 102.

A pair of right and left first guide plates 103 and a pair of right and left second guide plates 104 are disposed in series along the transfer direction D on both sides in the transfer direction D of the corrugated fiberboard S. The respective first guide plates 103 and the respective second guide plates 104 are disposed in series along the transfer direction D on the downstream sides of the respective second folding rails 102 in the transfer direction D. The respective first guide plates 103 and the respective second guide plates 104 are supported outside the pair of right and left lower frames 111. The respective first guide plates 103 are disposed to be approximately parallel in the transfer direction D, and the respective second guide plates 104 are disposed to be approximately parallel in the transfer direction D. However, downstream outer surface of the second guide plates 104 in the transfer direction D are formed in inclined surfaces.

In the respective first guide plates 103 and the respective second guide plates 104, positions in a width direction in a bending portion along the transfer direction D are disposed at positions in the width direction corresponding to the respective creasing lines 312 and 314 on the lower surface of the corrugated fiberboard S transferred in the transfer direction D. Accordingly, the corrugated fiberboard S is transferred while the sheet pieces 331 and 334 on the end portion sides in the width direction are folded downward with respect to the respective sheet pieces 332 and 333 on a center side in the width direction at positions at which the respective creasing lines 312 and 314 abut against bending portions of the respective first guide plates 103 and the respective second guide plates 104.

A pair of right and left first gauge roller groups 105 and a pair of right and left second gauge roller groups 106 are disposed in series along the transfer direction D on both sides in the transfer direction D of the corrugated fiberboard S. The respective first gauge roller groups 105 and the respective second gauge roller groups 106 are disposed so as to face each other outside the respective second folding rails 102, the respective first guide plates 103, and the respective second guide plates 104 in the width direction. The respective first gauge roller groups 105 include several first gauge rollers 114, the respective second gauge roller groups 106 includes several second gauge rollers 115, the respective gauge rollers 114 and 115 are rotatably supported by support plates 116 and 117, and the respective support plates 116 and 117 are supported outside the respective lower frames 111. In addition, the respective gauge rollers 114 and 115 can be driven and rotated synchronously by a drive device (not shown).

In the respective first gauge roller groups 105 and the respective second gauge roller groups 106, positions in the width direction of holding portions (recessed portions) along the transfer direction D are disposed at positions in the width direction corresponding to the respective creasing lines 312 and 314 on the lower surface of the corrugated fiberboard S transferred in the transfer direction D. In addition, shapes of the holding portions in the respective first gauge roller groups 105 and the respective second gauge roller groups 106 are changed according to the shape of the folding portion of the folded corrugated fiberboard S. Accordingly, after the corrugated fiberboard S is bent downward at the positions of the respective creasing lines 312 and 314, an outer peripheral portion (upper surface side) of the corrugated fiberboard S is held by the holding portions of the respective first gauge roller groups 105 and the respective second gauge roller groups 106, and thus, the corrugated fiberboard S is transferred while the sheet pieces 331 and 334 on the end portion sides in the width direction are folded with respect to the respective sheet pieces 332 and 333 on the center side in the width direction.

A pair of right and left forming belts 107 are provided in the transfer direction D on the downstream side of the lower transfer belt 63 (refer to FIG. 1) in the transfer direction D. Each forming belt 107 is an endless belt and is configured to be wound around several pulleys (not shown) supported by each lower frame 111 so that the forming belt 107 can circulate. In each of the circulating forming belts 107, an upper side thereof moves in the transfer direction D and a lower side thereof moves in a direction opposite to the transfer direction D. The respective forming belts 107 are inclined so as to be twisted in the transfer direction D such that the respective forming belts 107 come into contact with outer surfaces (upper surfaces) of the respective sheet pieces 331 and 334 formed by bending both end portions in the width direction of the corrugated fiberboard S downward so as to face the outer surfaces. Accordingly, when the corrugated fiberboard S is transferred while being supported by the respective folding rails 101 and 102, the respective guide plates 103 and 104, and the respective gauge roller groups 105 and 106, the respective forming belts 107 fold the sheet pieces 331 and 334 on the end side in the width direction while pressing the sheet pieces 331 and 334 downward and inward in order.

A pair of right and left folding bars 108 are provided on the downstream side in the transfer direction D, and a portion of each folding bar 108 is provided to overlap the second guide plate 104, the first gauge roller group 105, the second gauge roller group 106, and the forming belt 107 in the transfer direction D. Similarly to the respective forming belts 107, the respective folding bars 108 are provided so as to face and come into contact with the outer surfaces (the upper surfaces) of the respective sheet pieces 331 and 334 formed by bending both end portions in the width direction of the corrugated fiberboard S downward. Accordingly, when the corrugated fiberboard S is transferred while being supported by the respective folding rails 101 and 102, the respective guide plates 103 and 104, and the respective gauge roller groups 105 and 106, the respective folding bars 108 press the sheet pieces 331 and 334 on the end side in the width direction downward and inward in order, in cooperation with the respective forming belts 107.

In addition, a first folding rail adjustment device 121 and a second folding rail adjustment device 122 are provided, which adjust the position of each of the folding rails 101 and 102 in the width direction of the corrugated fiberboard S. The first folding rail adjustment device 121 moves the first folding rail 101 and the second folding rail 102 in parallel in the width direction of the corrugated fiberboard S so as to adjust the positions in the width direction in a state of maintaining horizontal angles of the first folding rail 101 and the second folding rail 102 in the transfer direction D. The second folding rail adjustment device 122 moves the first folding rail 101 in parallel in the width direction of the corrugated fiberboard S so as to adjust the position in the width direction in a state of maintaining the horizontal angle of the first folding rail 101 in the transfer direction D. In this case, the second folding rail adjustment device 122 moves the first folding rail 101 in the width direction of the corrugated fiberboard S, and thus, the second folding rail adjustment device 122 moves the connection shaft 112 side in the width direction of the corrugated fiberboard S with the connection shaft 113 of the second folding rail 102 as a supporting point and can adjust the position of the second folding rail 102 in the width direction and the horizontal angle of the second folding rail 102.

In addition, first gauge roller adjustment devices 123, second gauge roller adjustment devices 124, and third gauge roller adjustment devices 125 are provided, which adjust the positions of the respective gauge roller groups 105 and 106 in the width direction of the corrugated fiberboard S. The first gauge roller adjustment devices 123 moves the first gauge roller group 105 in parallel in the width direction of the corrugated fiberboard S so as to adjust the position in the width direction in a state of maintaining a horizontal angle of the first gauge roller group 105 in the transfer direction D. The second gauge roller adjustment device 124 moves the gauge roller 114 on the upstream side of the first gauge roller group 105 in the transfer direction D in the width direction of the corrugated fiberboard S with the gauge roller 114 on the downstream side of the first gauge roller group 105 in the transfer direction D as a supporting point and adjusts a horizontal angle of the first gauge roller group 105. The third gauge roller adjustment device 125 moves the gauge roller 115 on the downstream side of the second gauge roller group 106 in the transfer direction D in the width direction of the corrugated fiberboard S with the gauge roller 115 on the upstream side of the second gauge roller group 106 in the transfer direction D as a supporting point and adjusts a horizontal angle of the second gauge roller group 106.

The first folding rail adjustment device 121, the second folding rail adjustment device 122, the first gauge roller adjustment device 123, the second gauge roller adjustment device 124, and the third gauge roller adjustment device 125 are configured to be approximately similar to each other. Here, the second folding rail adjustment device 122 will be described as an example.

As shown in FIG. 5, a supporting shaft 132 extending in the horizontal direction from the lower frame 111 penetrates a support box 131, and the support box 131 is supported to be movable along an axial direction of the supporting shaft 132, that is, the width direction (the horizontal direction orthogonal to the transfer direction D) of the transferred corrugated fiberboard S. The first folding rail 101 is attached to the support box 131 via a bracket 133, and the first folding rail 101 includes a bending portion 101a which extends to be inclined outward and upward in the width direction.

A bearing portion 134 extends in the horizontal direction from the lower frame 111, and a tip portion of bearing portion 134 is rotatably supported by a rotating shaft 135. The rotating shaft 135 is disposed along the transfer direction D of the corrugated fiberboard S and an eccentric portion 136 is fixed to a tip portion of the rotating shaft 135. Axis centers of the rotating shaft 135 and the eccentric portion 136 are offset from each other by a predetermined distance. An opening portion 137 is formed in the lower portion of the support box 131, and the eccentric portion 136 is fitted into the opening portion 137. In addition, the rotating shaft 135 can be rotated by a drive device 138.

Accordingly, if the rotating shaft 135 and the eccentric portion 136 are rotated by the drive device 138, the eccentric portion 136 oscillates with respect to the rotating shaft 135, and thus, the support box 131 moves along the axial direction of the supporting shaft 132 by an offset amount of the axis center between the rotating shaft 135 and the eccentric portion 136. If the support box 131 moves along the axial direction of the supporting shaft 132, the first folding rail 101 fixed to the support box 131 moves along the width direction of the corrugated fiberboard S. The second folding rail adjustment device 122 specifies a rotation position of the eccentric portion 136 by the drive device 138, and thus, moves the first folding rail 101 in parallel in the width direction of the corrugated fiberboard S and adjusts the position of the first folding rail 101 in the width direction. In addition, the first folding rail 101 moves in the width direction, and thus, the second folding rail adjustment device 122 moves the connection shaft 112 side in the width direction of the corrugated fiberboard S with the connection shaft 113 of the second folding rail 102 as the supporting point and can adjust the position of the second folding rail 102 in the width direction and the horizontal angle of the second folding rail 102.

Similarly, the first folding rail adjustment device 121 can adjust the positions of the first folding rail 101 and the second folding rail 102 in the width direction, the first gauge roller adjustment device 123 can adjust the position of the first gauge roller group 105 in the width direction, the second gauge roller adjustment device 124 can adjust the position of the first gauge roller group 105 in the width direction and the horizontal angle of the first gauge roller group 105, and the third gauge roller adjustment device 125 can adjust the position of the second gauge roller group 106 in the width direction and the horizontal direction angle of the second gauge roller group 106.

A control device 126 is connected to the first folding rail adjustment devices 121, the second folding rail adjustment devices 122, the first gauge roller adjustment devices 123, the second gauge roller adjustment devices 124, and the third gauge roller adjustment devices 125 (refer to FIG. 2). When the second folding rail 102 is moved by the second folding rail adjustment device 122 (or the first folding rail adjustment device 121), the control device 126 controls the second gauge roller adjustment device 124 such that a gap between the second folding rail 102 and the first gauge roller group 105 falls within a predetermined gap region which is set in advance.

In addition, a guide measurement sensor 127 for measuring the position of each second folding rail 102 and a roller measurement sensor 128 for measuring the position of the first gauge roller group 105 are provided, and the measurement results are output to the control device 126. The control device 126 controls the second folding rail adjustment devices 122 and the second gauge roller adjustment devices 124 based on the positions of the second folding rails 102 and the positions of the first gauge roller groups 105.

Hereinafter, an operation of the sheet folding device 65 including control methods of the second folding rail adjustment devices 122 and the second gauge roller adjustment devices 124 by the control device 126 will be described.

As shown in FIGS. 2 to 4, if the corrugated fiberboard S on which the creasing lines 312, 313, and 314 are formed is guided by the upper transfer belt 62 and the lower transfer belt 63 and reaches the first folding rails 101, the corrugated fiberboard S is transferred such that the respective creasing lines 312 and 314 abut against the bending portions of the respective first folding rails 101. In addition, in a process in which the corrugated fiberboard S is transferred on the respective first folding rails 101 and the respective second folding rails 102, the respective forming belt 107 press the sheet pieces 331 and 334 on the end portion sides in the width direction of the corrugated fiberboard downward and the respective folding bars 108 press the sheet pieces 331 and 334 on the end portion sides in the width direction downward in cooperation with the respective forming belts 107.

Accordingly, in the corrugated fiberboard S, the sheet pieces 331 and 334 on the end portion sides in the width direction are folded downward with respect to the respective sheet pieces 332 and 333 on the center side in the width direction at positions at which the respective creasing lines 312 and 314 abut against bending portions of the respective first folding rails 101 or the respective second folding rails 102, and thus, the folding portion is formed. In addition, in a process in which the corrugated fiberboard S is transferred on the respective second folding rails 102, an outer peripheral portion of the folding portion is held in order by the holding portions (recessed portion) of the respective first gauge roller groups 105 and the respective second gauge roller groups 106, and thus, the sheet pieces 331 and 334 on the end portion sides in the width direction are folded so as to come into contact with the respective sheet pieces 332 and 333 on the center side in the width direction. In this way, a flat corrugated box is formed.

However, the corrugated fiberboard S has different rigidities according to a thickness, a nature, a shape, or the like of a liner or a core paper constituting the corrugated fiberboard S. When the corrugated fiberboard S having a high rigidity is clamped by the respective second folding rails 102 and the respective first gauge roller groups 105, the corrugated fiberboard S is appropriately bent at the positions of the respective creasing lines 312 and 313. However, when the corrugated fiberboard S having a low rigidity is clamped by the respective second folding rails 102 and the respective first gauge roller groups 105, the corrugated fiberboard S is bent inside the respective creasing lines 312 and 313.

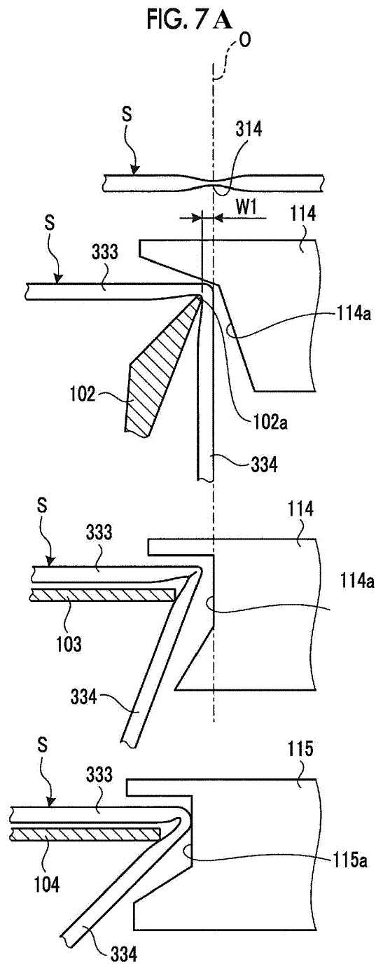

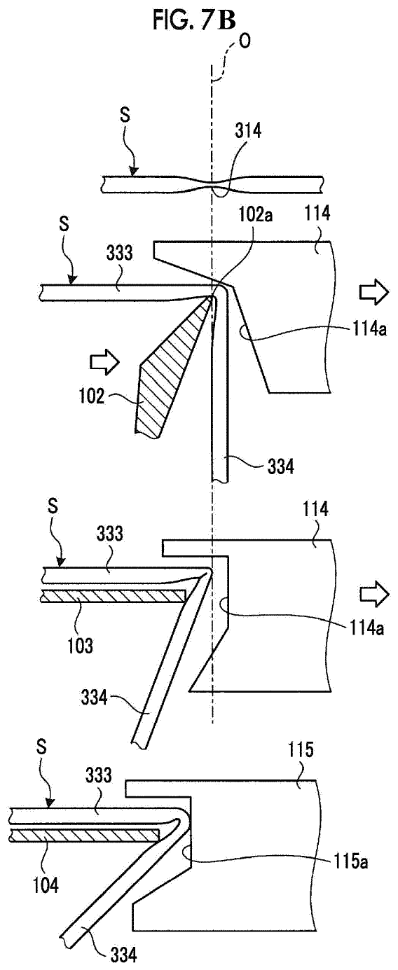

FIGS. 7A and 7B are schematic views showing a bending state of a corrugated fiberboard in the related art. In FIG. 7, an upper cross section indicates a position of the most upstream first gauge roller 114 in the first gauge roller group 105, an intermediate cross section indicates a position of the first gauge roller 114 facing the first guide plate 103, and a lower cross section indicates a position of the second gauge roller 115 facing the second guide plate 104.

As shown in FIG. 7A, first, the corrugated fiberboard S is clamped by a bending portion 102a of the second folding rail 102 and a recessed portion 114a of the first gauge roller 114, and thus, the sheet piece 334 is bent by approximately 90° with respect to the sheet piece 333. Next, the corrugated fiberboard S is clamped by the first guide plate 103 and the recessed portion 114a of the first gauge roller 114, and thus, the sheet piece 334 is bent by 90° or more with respect to the sheet piece 333. In addition, the corrugated fiberboard S is clamped by the second guide plate 104 and a recessed portion 115a of the second gauge roller 115, and thus, the sheet piece 334 is further bent with respect to the sheet piece 333.

In this case, in a case where the rigidity of the corrugated fiberboard S is low, when the corrugated fiberboard S is clamped by the bending portion 102a of the second folding rail 102 and the recessed portion 114a of the first gauge roller 114 and is bent, the corrugated fiberboard S is bent at a position offset by a width W1 inward from a position (reference position O) of the creasing line 314. Accordingly, when the corrugated fiberboard S is clamped by the first guide plate 103 and the recessed portion 114a of the first gauge roller 114, a gap is generated between the corrugated fiberboard S and the first gauge roller 114, and thus, when the corrugated fiberboard S is clamped by the second guide plate 104 and the second gauge roller 115, the bending position is scattered.

In this case, in the related art, as shown in FIG. 7A, the second folding rail 102 moves outward in the width direction and the first gauge roller 114 moves outward in the width direction. Accordingly, when the corrugated fiberboard S is clamped by the bending portion 102a of the second folding rail 102 and the recessed portion 114a of the first gauge roller 114 and is bent, the corrugated fiberboard S is appropriately bent at the position (reference position O) of the creasing line 314. However, when the corrugated fiberboard S is clamped by the first guide plate 103 and the recessed portion 114a of the first gauge roller 114, a gap is generated between the corrugated fiberboard S and the first gauge roller 114 which moves outward in the width direction, and thus, when the corrugated fiberboard S is clamped by the second guide plate 104 and the second gauge roller 115, the bending position is scattered.

Accordingly, in the present embodiment, when the rigidity of the corrugated fiberboard S is low, the second folding rail 102 moves outward in the width direction, and a predetermined gap is maintained between the first guide plate 103 and the first gauge roller 114 is maintained while the first gauge roller 114 positioned at a position facing the second folding rail 102 moves outward in the width direction.

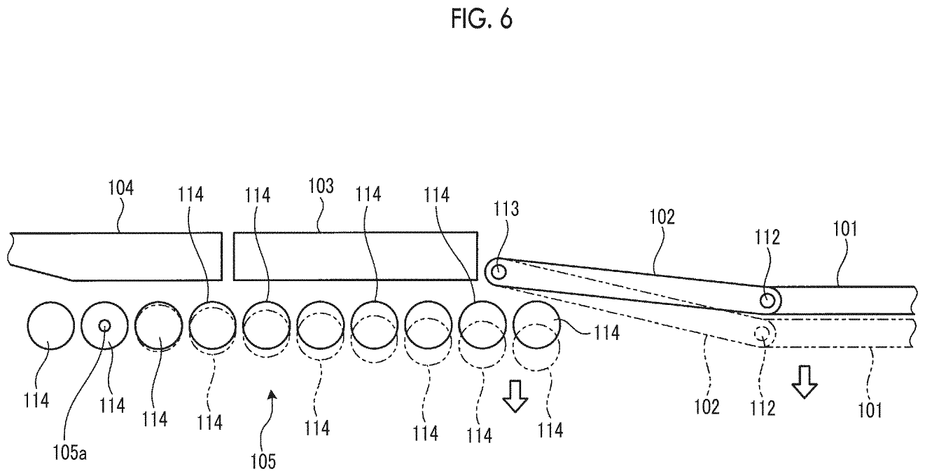

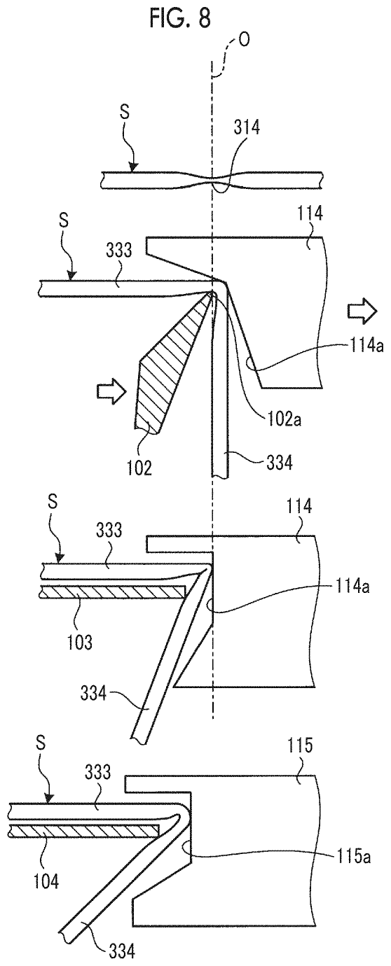

FIG. 6 is an explanatory view showing a position adjustment method of the folding rails and the gauge rollers, and FIG. 8 is a schematic view showing a bending state of the corrugated fiberboard of the present embodiment. In addition, in FIG. 8, the upper cross section, the intermediate cross section, and the lower cross section are positioned at positions similar to those of FIGS. 7A and 7B.

As shown in FIGS. 6 and 8, when the corrugated fiberboard S having a low rigidity is processed, the second folding rail 102 is rotated outward about the connection shaft 113 via the first folding rail 101 by the second folding rail adjustment device 122, and for example, the bending portion 102a of the second folding rail 102 moves to the position (reference position O) of the creasing line 314. In addition, according to this, the first gauge roller group 105 is rotated outward about a supporting point 105a by the second gauge roller adjustment device 124, and the first gauge roller 114 facing the second folding rail 102 moves outward in the width direction. In this case, the gap between the second folding rail 102 and the first gauge rollers 114 facing each other falls within a predetermined gap region which is set in advance.

In addition, the first gauge roller group 105 rotates outward about the supporting point 105a, the first gauge roller 114 facing the second folding rail 102 largely moves outward in the width direction, and an appropriate gap between the first gauge roller 114 and the second folding rail 102 is maintained. Meanwhile, in the first gauge roller group 105, the respective first gauge rollers 114 disposed on the supporting point 105a side hardly move outward in the width direction, and thus, the first gauge roller group 105 is hardly separated from the first guide plate 103, and an appropriate gap is maintained.

Accordingly, as shown in FIG. 8, first, the corrugated fiberboard S, the corrugated fiberboard S is clamped by the bending portion 102a of the second folding rail 102 which has moved outward in the width direction and the recessed portion 114a of the first gauge roller 114 which has moved outward in the width direction, and thus, the sheet piece 334 is bent appropriately at approximately 90° at the position (reference position O) of the creasing line 314 with respect to the sheet piece 333. Next, the corrugated fiberboard S is clamped by the first guide plate 103 and the recessed portion 114a of the first gauge roller 114 which hardly moves outward in the width direction, and thus, the gap is not generated between the corrugated fiberboard S and the first gauge roller 114, and the sheet piece 334 is bent by 90° or more with respect to the sheet piece 333. In addition, the corrugated fiberboard S is clamped by the second guide plate 104 and the recessed portion 115a of the second gauge roller 115, the sheet piece 334 is bent at an appropriate position with respect to the sheet piece 333, and the bending position is not scattered.

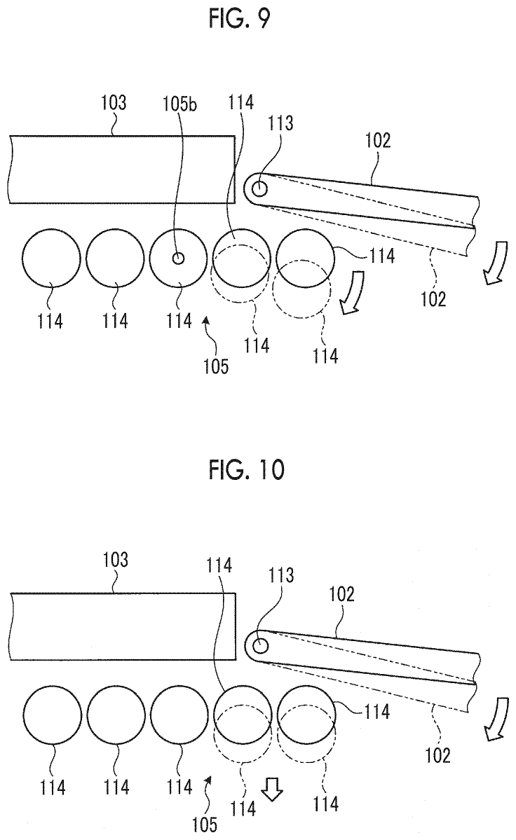

In addition, in the above-described embodiment, when the second folding rail 102 moves outward in the width direction, the upstream side of the first gauge roller group 105 in the transfer direction D is moved outward in the width direction of the corrugated fiberboard S about the supporting point 105a of the first gauge roller group 105 on the downstream side in the transfer direction D by the second gauge roller adjustment device 124. However, the present invention is not limited to this. FIG. 9 is a schematic view showing a first modification example of the sheet folding device of the present embodiment, and FIG. 10 is a schematic view showing a second modification example of the sheet folding device of the present embodiment.

In the first modification example, as shown in FIG. 9, when two first gauge rollers 114 of the first gauge roller group 105 positioned on the most upstream side in the transfer direction D of the corrugated fiberboard S face the second folding rail 102 in the width direction, in the first gauge roller group 105, the two first gauge rollers 114 on the most upstream side can integrally rotate with the third first gauge roller 114 from the most upstream side in the transfer direction D of the corrugated fiberboard S as a supporting point 105b. Accordingly, when the second folding rail 102 moves outward in the width direction, only the two first gauge rollers 114 facing the second folding rail 102 move outward in the width direction, and other first gauge rollers 114 can be maintained at positions thereof.

In addition, in the second modification example, as shown in FIG. 10, when the two first gauge rollers 114 of the first gauge roller group 105 positioned on the most upstream side in the transfer direction D of the corrugated fiberboard S face the second folding rail 102 in the width direction, the two first gauge rollers 114 on the upstream side can integrally move in parallel along the width direction. Accordingly, when the second folding rail 102 moves outward in the width direction, only the two first gauge rollers 114 facing the second folding rail 102 move outward in the width direction, and other first gauge rollers 114 can be maintained at positions thereof.

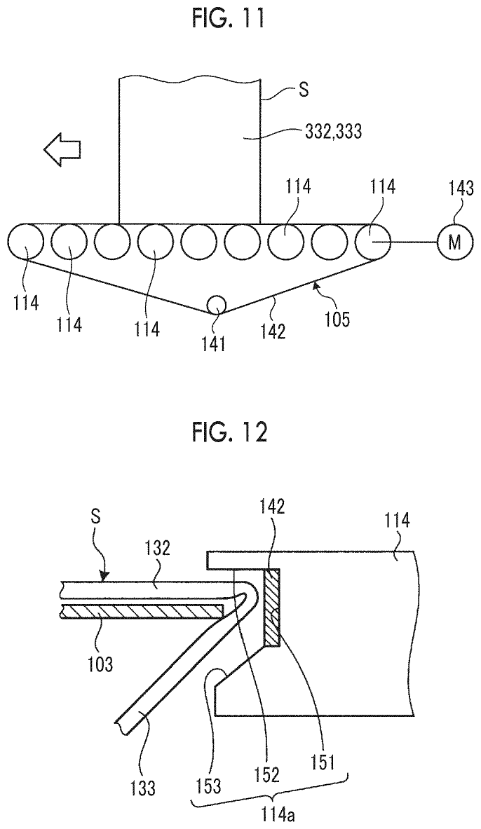

In addition, in the above-described embodiment, the respective gauge rollers 114 and 115 of the respective gauge roller groups 105 and 106 come into direct contact with the bending portion of the corrugated fiberboard S to be guided. However, the present invention is not limited to this configuration. FIG. 11 is a schematic view showing a third modification example of the sheet folding device of the present embodiment, and FIG. 12 is a sectional view of a gauge roller.

As shown in FIGS. 11 and 12, the first gauge roller group 105 includes several first gauge rollers 114, and a holding belt 142 is wound around the respective first gauge rollers 114 and a tension roller 141. The recessed portion 114a for holding the bending portion of the corrugated fiberboard S is provided in each first gauge roller 114, and the recessed portion 114a includes a lower surface portion 151, a bottom surface portion 152, and an inclined surface portion 153. In addition, in each first gauge roller 114, the holding belt 142 is wound around the bottom surface portion 152 of the recessed portion 114a. In addition, the drive device 143 is drivingly connected to one first gauge roller 114 of the several first gauge rollers 114.

Accordingly, if the one first gauge roller 114 is driven by the drive device 143, all the first gauge rollers 114 can be synchronously rotated via the holding belt 142. In addition, the bending portion of the corrugated fiberboard S is continuously supported by the holding belt 142 provided on the recessed portions 114a of the respective first gauge rollers 114, the corrugated fiberboard S does not fall between the respective first gauge rollers 114, and a posture of the corrugated fiberboard S does not deteriorate.

In addition, here, the tension roller 141, the holding belt 142, the drive device 143 is provided in the first gauge roller group 105, but may be also applied to the second gauge roller group 106.

In this way, the sheet folding device of the present embodiment includes the folding rails 101 and 102 which are disposed along the transfer direction D on both sides in the transfer direction D of the corrugated fiberboard S, the guide plates 103 and 104 which are disposed on downstream sides of the folding rails 101 and 102 along the transfer direction D on both sides in the transfer direction D of the corrugated fiberboard S, the gauge roller groups 105 and 106 including several gauge rollers 114 and 115 which are disposed outside the folding rails 101 and 102 and the guide plates 103 and 104 in a width direction of the corrugated fiberboard S, along the transfer direction D of the corrugated fiberboard S, the folding rail adjustment devices 121 and 122 which adjust the positions of the folding rails 101 and 102 in the width direction of the corrugated fiberboard, and the second gauge roller adjustment device 124 which adjusts the position of at least the gauge roller 114 of the gauge roller groups 105 and 106, which is disposed to face the second folding rail 102, in the width direction of the corrugated fiberboard S.

Accordingly, when the position of the second folding rail 102 in the width direction is adjusted by the second folding rail adjustment device 122, the position in the width direction of the first gauge roller 114 of the first gauge roller group 105 facing the second folding rail 102 is adjusted by the second gauge roller adjustment device 124. Accordingly, even when the positions of the second folding rail 102 and the first gauge roller 114 facing each other or the gap therebetween is adjusted according to a material or the like of the corrugated fiberboard S, the gap between the first guide plate 103 and the first gauge roller 114 is maintained at an appropriate gap, the corrugated fiberboard S can be bent at an appropriate position, and it is possible to improve bending accuracy of the corrugated fiberboard S.

In the sheet folding device of the present embodiment, the second gauge roller adjustment device 124 can move the upstream side of the first gauge roller group 105 close to or away from the second folding rail 102 with the downstream side of the first gauge roller group 105 in the transfer direction D of the corrugated fiberboard S as the supporting points 105a and 105b. Accordingly, when the position of the second folding rail 102 in the width direction is adjusted, the first gauge roller group 105 rotates with the downstream side as the supporting point, the position of the first gauge roller 114 on the upstream side in the width direction is adjusted, the position of the first gauge roller 114 facing the second folding rail 102 can be appropriately adjusted, and it is possible to bend the corrugated fiberboard S at an appropriate position without largely changing the position of the first gauge roller 114 facing the first guide plate 103.

In the sheet folding device of the present embodiment, the second gauge roller adjustment device 124 can move the first gauge roller 114 of the first gauge roller group 105 disposed to face the second folding rail 102 close to or away from the second folding rail 102. Accordingly, when the position of the second folding rail 102 in the width direction is adjusted, only the first gauge roller 114 disposed to face the second folding rail 102 moves and the position thereof in the width direction is adjusted, the position of the first gauge roller 114 facing the second folding rail 102 can be appropriately adjusted, and it is possible to bend the corrugated fiberboard S at an appropriate position without changing the position of the first gauge roller 114 facing the first guide plate 103.

In the sheet folding device of the present embodiment, the first folding rail 101 and the second folding rail 102 which are disposed in series and have the end portions rotatably connected to each other are provided as the second folding rail, the first folding rail adjustment device 121 can move the first folding rail 101 and the second folding rail 102 in parallel in the width direction, and the second folding rail adjustment device 122 can change the angle of the second folding rail 102 by moving the first folding rail 101 in parallel in the width direction. Accordingly, the first folding rail 101 and the second folding rail 102 move in parallel in the width direction, the first folding rail 101 moves in parallel in the width direction so as to change the angle of the second folding rail 102, and it is possible to easily adjust the position of the first gauge roller 114 facing the second folding rail 102.

In the sheet folding device of the present embodiment, the first gauge roller group 105 and the second gauge roller group 106 which are disposed in series are provided as the gauge roller group, the first gauge roller adjustment device 123 can move the first gauge roller group 105 in parallel in the width direction, and the second gauge roller adjustment device 124 can change the angle of the first gauge roller group 105. Accordingly, the angle of the first gauge roller group 105 is changed, and thus, it is possible to easily adjust the position of the gauge roller 114 facing the second folding rail 102.

In the sheet folding device of the present embodiment, the control device 126 which controls the folding rail adjustment devices 121 and 122 and the gauge roller adjustment device 123, 124, and 125 is provided, and the control device 126 controls the second gauge roller adjustment device 124 such that the gap between the second folding rail 102 and the first gauge roller 114 when the second folding rail 102 is moved by the second folding rail adjustment device 122 falls within a predetermined gap region which is set in advance. Accordingly, the position of the second folding rail 102, the position of the first gauge roller 114, and the gap between the second folding rail 102 and the first gauge roller 114 can be easily adjusted to appropriate positions or an appropriate gap, and thus, workability can be improved.

In the sheet folding device of the present embodiment, the guide measurement sensor 127 which measures the position of the second folding rail 02, the roller measurement sensor 128 which measure the position of the first gauge roller group 105, and the control device 126 which controls the second folding rail adjustment device 122 and the second gauge roller adjustment device 124 based on the measurement result of the guide measurement sensor 127 and the measurement result of the roller measurement sensor 128 are provided. Accordingly, it is possible to accurately adjust the position of the second folding rail 102, the position of the first gauge roller 114, and the gap between the second folding rail 102 and the first gauge roller 114, and it is possible to improve quality of a product.

In the sheet folding device of the present embodiment, the recessed portion 114a holding the bending portion of the corrugated fiberboard S is provided in each of the several first gauge rollers 114, and the holding belt 142 is wound around the bottom surface portion 152 of the recessed portion 114a of each of the several first gauge rollers 114. Accordingly, the corrugated fiberboard S is transferred while the bending portion is continuously supported by the holding belt 142 provided in the recessed portion 114a of each gauge roller 114, the corrugated fiberboard S does not fall between the respective first gauge rollers 114, the posture of the corrugated fiberboard S does not deteriorate, and the corrugated fiberboard S can be stably transferred.

In the sheet folding device of the present embodiment, the drive device 143 which drives the first gauge roller 114 is provided. Accordingly, if the one first gauge roller 114 is driven by the drive device 143, the drive force is transmitted to all the first gauge rollers 114 via the holding belt 142, all the first gauge rollers 114 can be synchronously rotated, the drive system of the first gauge roller 114 is simplified, and a cost can be reduced.

In addition, in the box making machine of the present embodiment, the sheet feeding section 11, the printing section 21, the slotter creaser section 31, the die cutting section 41, the folding section 61, and the counter-ejector section 71 are provided, the sheet folding device 65 is provided in the folding section 61. Accordingly, the printing is performed on the corrugated fiberboard S from the sheet feeding section 11 in the printing section 21, the creasing line processing and the slicing are performed in the slotter creaser section 31, the corrugated fiberboard S is folded in the folding section 61 such that the end portions are joined to each other so as to form the corrugated box B, and the corrugated boxes B are stacked while being counted in the counter-ejector section 71. In this case, even when the positions of the second folding rail 102 and the first gauge roller 114 facing each other or the gap therebetween is adjusted according to a material or the like of the corrugated fiberboard S, the sheet folding device 65 maintains the gap between the first guide plate 103 and the first gauge roller 114 at an appropriate gap and can bend the corrugated fiberboard S at an appropriate position, it is possible to improve bending accuracy of the corrugated fiberboard S, and it possible to improve the quality of the product.

In addition, in the above-described embodiment, each of the first folding rail adjustment device 121, the second folding rail adjustment device 122, the first gauge roller adjustment device 123, the second gauge roller adjustment device 124, and the third gauge roller adjustment device 125 is configured of an eccentric type device. However, the present invention is not limited to this, and for example, a screw type device, a cylinder type device, or the like may be adopted.

In addition, in the above-described embodiment, the folding rails 101 and 102, the guide plates 103 and 104, and the gauge roller groups 105 and 106 are divided into two. However, the present invention is not limited to this configuration, and may be into three or more.

In addition, in the above-described embodiment, the box making machine 10 includes the sheet feeding section 11, the printing section 21, the slotter creaser section 31, the die cutting section 41, the folding section 61, and the counter-ejector section 71. However, the present invention is not limited to this configuration. For example, in a case where the corrugated fiberboard S does not require a hand hole, the die cutting section 41 may be omitted. In addition, the box making machine 10 may include only the sheet feeding section 11, the printing section 21, and the slotter creaser section 31.

1. A sheet folding device which bends and folds both end portions in a width direction of a transferred corrugated fiberboard, comprising:
folding rails which are disposed along a transfer direction on both sides in the transfer direction of the corrugated fiberboard;
guide plates which are disposed on downstream sides of the folding rails along the transfer direction on both sides in the transfer direction of the corrugated fiberboard;
a gauge roller group including several gauge rollers which are disposed outside the folding rails and the guide plates in a width direction of the corrugated fiberboard, along the transfer direction of the corrugated fiberboard;
a folding rail adjustment device which adjusts positions of the folding rails in the width direction of the corrugated fiberboard; and
a gauge roller adjustment device which adjusts a position of at least the gauge roller of the gauge roller group, which is disposed to face the folding rail, in the width direction of the corrugated fiberboard.

2. The sheet folding device according to claim 1,
wherein the gauge roller adjustment device moves an upstream side of the gauge roller group close to or away from the folding rail with a downstream side of the gauge roller group in the transfer direction of the corrugated fiberboard as a supporting point.

3. The sheet folding device according to claim 1,
wherein the gauge roller adjustment device moves the gauge roller of the gauge roller group disposed to face the folding rail close to or away from the folding rail.

4. The sheet folding device according to claim 1,
wherein the folding rail includes a first folding rail and a second folding rail which are disposed in series in the transfer direction of the corrugated fiberboard and have end portions rotatably connected to each other, and the folding rail adjustment device moves the first folding rail and the second folding rail in parallel in the width direction of the corrugated fiberboard and changes an angle of the second folding rail by moving the first folding rail in parallel in the width direction of the corrugated fiberboard.

5. The sheet folding device according to claim 1,
wherein the gauge roller group includes a first gauge roller group and a second gauge roller group which are disposed in series in the transfer direction of the corrugated fiberboard, and the gauge roller adjustment device moves the first gauge roller group in parallel in the width direction of the corrugated fiberboard and changes angles of the first gauge roller group and the second gauge roller group independently.

6. The sheet folding device according to claim 1, further comprising:
a control device which controls the folding rail adjustment device and the gauge roller adjustment device,
wherein the control device controls the gauge roller adjustment device such that a gap between the folding rail and the gauge roller when the folding rail is moved by the folding rail adjustment device falls within a predetermined gap region which is set in advance.

7. The sheet folding device according to claim 1, further comprising:
a guide measurement sensor which measures a position of the folding rail;
a roller measurement sensor which measures a position of the gauge roller group; and
a control device which controls the folding rail adjustment device and the gauge roller adjustment device based on a measurement result of the guide measurement sensor and a measurement result of the roller measurement sensor.

8. The sheet folding device according to claim 1,
wherein a recessed portion holding a bending portion of the corrugated fiberboard is provided in each of the several gauge rollers, and a holding belt is wound around a bottom surface portion of the recessed portion of each of the several gauge rollers.

9. The sheet folding device according to claim 8, further comprising:
a drive device which drives the gauge roller.

10. A box making machine comprising:
a sheet feeding section which supplies a corrugated fiberboard;
a printing section which performs printing on the corrugated fiberboard;
a slotter creaser section which performs creasing line processing and slicing on the printed corrugated fiberboard;
a folding section which includes the sheet folding device according to claim 1; and
a counter-ejector section which stacks flat corrugated boxes while counting the flat corrugated boxes and thereafter, discharges the flat corrugated boxes every predetermined number.
